(19) United States
(12) Patent Application Publication
(10) Pub. No.: US 2004/0044583 A1
(43) Pub. Date: Mar. 4, 2004

(54) Email reminder apparatus and method

(76) Inventor: Thomas Michael Thibault, San Diego, CA (US)

Correspondence Address: THOMAS THIBAULT, 11196 VISTA SORRENTO PARKWAY, #306, SAN DIEGO, CA, 92130, US

(21) Appl. No.: 10/233,048

(22) Filed: Aug. 30, 2002

(51) Int. Cl. G06F 17/60

(52) U.S. Cl. 705/26

(57) ABSTRACT

A method and apparatus for providing an email reminder. In one embodiment, a method for providing an email reminder comprises determining that an outgoing email has been sent and querying a sender of the outgoing email if the sender would like to receive the email reminder. A command to provide the email reminder is received. It is then determined if a response to the outgoing email has been received from a recipient of the outgoing email. If a response from the recipient is not received within a predetermined time period, a notification is provided to said sender indicating same.

### SCOPE

The present invention relates to electronic messaging. More specifically, the present invention relates to a method and apparatus for reminding a message sender whether or not a reply message has been received.

### BACKGROUND

Electronic mail, otherwise known as email, is a well-known method for sending information between two or more computers, usually over a data network, such as the Internet. Many email software programs are available, such as Microsoft Outlook, Microsoft Outlook Express, Eudora, and others. Some Internet portals offer free email as well. A prime example is Yahoo Incorporated, which offers free email service to users.

Typically, a user enters text information to be sent to one or more recipients. The user may also attach data files to the text message. The user enters one or more email recipients' email addresses in the appropriate entries, then “sends” the email using an appropriate command. The email is then transmitted to the user's service provider, where it is then forwarded to the email address(s) contained in the email.

One problem with the current method of sending email is that a user has no way of knowing if a response to an outgoing email has been received. For example, it might be desirable for a user to receive a response to an email sent to a second party. Currently, the user may incorporate a query into the outgoing email asking that the recipient acknowledge receipt of the email. The recipient may then choose to alert the user that the email message was received, and a notification is sent back to the user.

Unfortunately, however, there does not exist a way for the user to know if a response to the email was sent by the recipient. Often, the user expects a response from the emails that are sent. If a response to the email is not sent in a timely manner, the user may very well forget that an email was sent to the particular recipient. It may be days or weeks later that the user realizes that a response to the email was not received.

### SUMMARY

A method and apparatus for providing an email reminder. In one embodiment, an email reminder is provided by a method, the method comprising receiving a command to provide an email reminder to an outgoing email, determining whether or not a response email from a recipient of said outgoing email has been received subsequent to said command, and providing a notification if said response email from said recipient has not been received within a predetermined time period.

In another embodiment, an email reminder is provided by a method, the method comprising determining that an outgoing email has been sent, querying a sender of said outgoing email if said sender would like to receive said email reminder, receiving a command to provide said email reminder, determining if an incoming email has been sent by a recipient of said outgoing email, and providing a notification to said sender if a response to said outgoing email by said recipient has not been received within a predetermined time period.

In another embodiment, an email reminder is provided by a signal-bearing medium tangibly embodying a program of machine-readable instructions executable by a digital processing apparatus to perform a method for providing an email reminder, said method comprising operations of receiving a command to provide an email reminder to an outgoing email, determining whether or not a response email from a recipient of said outgoing email has been received subsequent to said command, and providing a notification if said response email from said recipient has not been received within a predetermined time period.

In yet another embodiment, an email reminder is provided by a signal-bearing medium tangibly embodying a program of machine-readable instructions executable by a digital processing apparatus to perform a method for providing an email reminder, said method comprising operations of determining that an outgoing email has been sent, querying a sender of said outgoing email if said sender would like to receive said email reminder, receiving a command to provide said email reminder, determining if an incoming email has been sent by a recipient of said outgoing email, and providing a notification to said sender if a response to said outgoing email by said recipient has not been received within a predetermined time period.

In still another embodiment, an email reminder is provided by an apparatus, the apparatus comprising a user interface for allowing a user to request a notification if a response to an outgoing email has not been received within a predetermined time period, and for providing said notification to said user, a memory for storing a recipient of said outgoing email, a network interface for sending said outgoing email and for receiving said response, and a processor for determining whether or not said response has been received from said recipient within a predetermined time period, and for providing said notification if said response is not received within said predetermined time period.

### BRIEF DESCRIPTION OF THE DRAWINGS

The objects presented are best understood when viewed in accordance with the following description of the drawings:

FIG. 1 illustrates a functional diagram of a communication system in which the email reminder apparatus and method may be used;

FIG. 2 illustrates a functional block diagram of an apparatus used to provide an email reminder;

FIG. 3 is an illustration representing a signal-bearing medium tangibly embodying a program of machine-readable instructions executable by a digital processing apparatus to perform a method for providing an email reminder; and

FIG. 4 is a flow diagram illustrating a method for providing an email reminder.

### DETAILED DESCRIPTION

The following description details several embodiments of a method and apparatus for providing an email reminder. An email reminder comprises a status of emails received in response to an outgoing email. An email reminder may be used, for example, to remind a sender of an outgoing email that a response from one or more recipients of the outgoing email has not been received within a predetermined timer period. In another example, an email reminder may notify a sender of an outgoing email when a response to an outgoing email has been received.

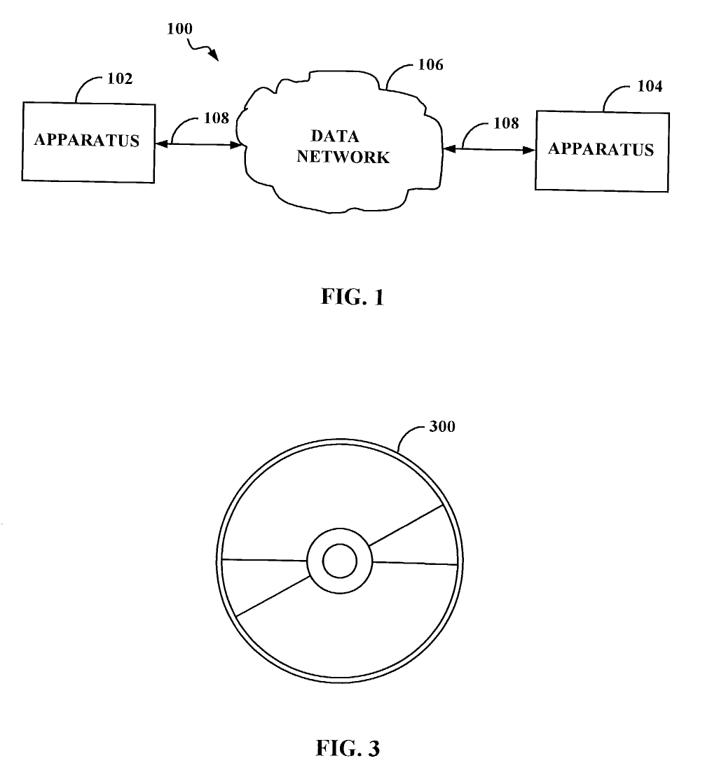

FIG. 1 illustrates a functional diagram of a communication system 100 in which the email reminder apparatus and methods may be used. Apparatus 102 and apparatus 104 each comprise a digital processing device capable of executing machine-readable instructions for performing a variety of tasks. Common examples of apparatus 102 and apparatus 104 each include a desktop computer, a laptop computer, a personal digital assistant (PDA), an Internet Service Provider (ISP) server, or a wireless telephone cable of transmitting and receiving text messages. Of course, apparatus 102 and apparatus 104 do not necessarily comprise the same type of apparatus.

One common task that an apparatus may perform is sending and receiving text messages, commonly known as electronic mail, or email. There exists today a number of email software programs for allowing users to send and receive email. Examples include Microsoft Outlook, Microsoft Outlook Express, Eudora, and others. In these cases, an email software program is loaded into apparatus 102, then executed by a digital processing device, such as a Pentium-class microprocessor sold by Intel Incorporated of Santa Clara, Calif. The email software program allows a user of apparatus 102 to compose an email for transmission to one or more other apparatus, such as apparatus 104. The email generally comprises a text message, although one or more data files may usually be appended to the email. The email is transmitted using known data protocols, generally over a data network 106, such as the Internet. Email is routed through data network 106 to apparatus 104.

The communication link 108 between apparatus 102 and data network 106 may comprise one of a number of well-known data communication links, such as a telephone cable, a coaxial cable, a fiber optic cable, or even a wireless link. Generally, access to data network 106 is provided by an internet service provider, such as America Online, Microsoft Network, or any one of a number of smaller service providers. In the case of wireless communications, a wireless service provider may provide access to data network 106.

The ability to compose and transmit email may also be provided by an on-line business, such as Yahoo Incorporated of Sunnyvale, Calif. In this example, a user of apparatus 102 communicates with an email software program running on a server owned or leased by Yahoo. The communication between apparatus 102 and the server transpires, generally, over a data network, such as the Internet. A user of apparatus 102 may compose an email message, and transmit the message to one or more users, much the same as if the email software program were running on apparatus 102.

When a user of apparatus 102 wishes to send an email to apparatus 104, the user generally selects a command to compose a new email message, using the appropriate command(s) for the particular email software program in use. Typically, a new “window” appears in which the user can enter a text message in the body of the email. The user may also attach one or more data files for transmission with the text message. Importantly, the user also enters one or more recipient names into one or more text fields used to denote an email recipient(s). The recipient names generally comprise an email address, the email address comprising a user identifier followed by an “@” symbol, then followed by a mail server identifier or domain name. When entry of the recipient information is complete, the user enters an appropriate command to send the email message to the denoted recipient(s).

In one embodiment, after the user enters the command to send the email, a query is provided to the user asking whether or not the user would like an email reminder. In other embodiments, a user may request an email reminder during composition of an outgoing email message, or request an email reminder to an email message that has been previously sent.

When an email reminder is desired, a predetermined time period may be associated with the outgoing email so that the user can be notified if one or more recipients have not responded to the outgoing email within the predetermined time period. Alternatively, the predetermined time period is associated with a recipient, rather than the outgoing message. In this way, in the case of an outgoing email having more than one recipient, an email reminder can be separately defined for each recipient.

In one embodiment, the user defines the predetermined time period during a command to provide an email reminder. In another embodiment, the predetermined time period comprises a default time period used for each outgoing email to which an email reminder is desired. In yet another embodiment, the predetermined time period is fixed, but the user is allowed to alter it for each email reminder that is requested.

After the user requests an email reminder, apparatus 104 monitors incoming email to determine if a response email from at least one recipient of the outgoing email has been received. For example, as email is received, apparatus 104 compares the “From” field of each email to the named recipient(s) of the outgoing email. In another embodiment, the “Subject” field is compared to the subject field of the outgoing email in addition or alternatively to comparing the “From” field. If the “From” field and/or the “Subject” field matches at least one of the recipients and/or subject field of the outgoing email, the email reminder may be canceled, and no further action is taken. If, however, no email is received where the “From” field and/or the “Subject” field matches at least one of the recipients and/or subject field of the outgoing email within the predetermined time period, a notification is provided to the user, generally via apparatus 104, that a response email from one or more recipients has not been received.

The notification comprises an audible, visual, or both, indication. The notification may simply comprise the audible/visual alert, informing the user that at least one outgoing email has not been responded to, and requiring the user to manually determine which outgoing email was not responded to. In another embodiment, the notification comprises a pop-up window or email message identifying which outgoing email was not responded to. Other information may be provided as well, such as the name or names of the recipients who have not responded, those recipients that have responded (in the case of multiple recipients) and the date and times of the responses, a description of the “Subject” field, the entire text of the outgoing email, or only a portion of the text of the outgoing email.

Upon receiving the notification, a user is reminded that an email response to a potentially important outgoing email has not been received, thereby prompting further action by the user to obtain some sort of response from the one or more recipients who did not respond.

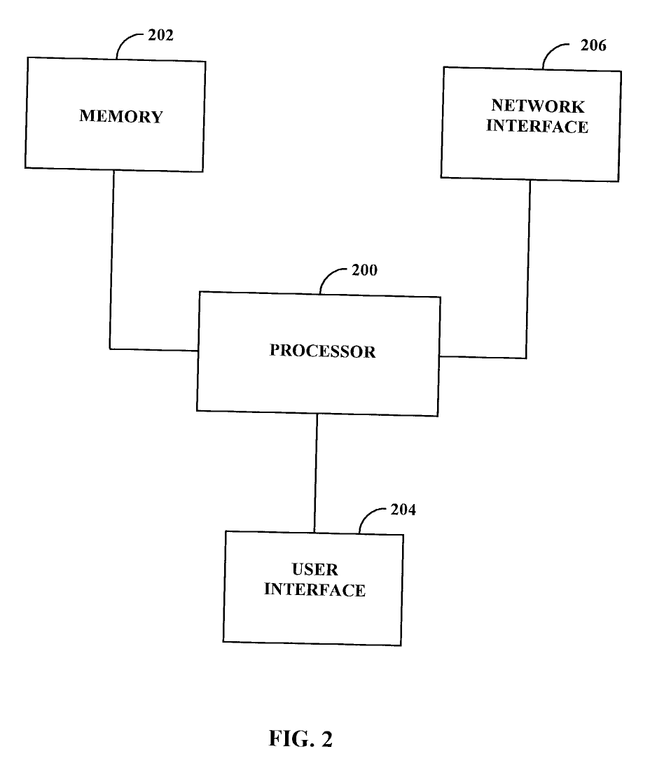

FIG. 2 illustrates a functional block diagram of apparatus 102, used to provide an email reminder. Shown are processor 200, memory 202, user interface 204, and network interface 206. Processor 200 executes machine-readable instructions stored in memory 202 for providing an email reminder, as well as other functions. Processor 200 comprises, generally, a digital microprocessor and supporting circuitry commonly used in millions of personal computers worldwide. One example of processor 200 comprises a Pentium class microprocessor manufactured by Intel Incorporated of Santa Clara, Calif. Of course, processor 200 might alternatively comprise other types of digital microprocessors, suited for the particular type of apparatus 104.

Memory 202 comprises one or more electronic, optical, or other type of memories for storing information pertaining to providing an email reminder. For example, memory 202 could comprise a random access memory (RAM), a read-only memory (ROM), an electrically-erasable read-only memory (EEPROM), an ultra-violet read-only memory (UVPROM), a flash memory, a hard drive, a tape drive, or other type of electronic memory. A set of machine-readable computer instructions are generally stored in memory 202 for processor 202 to execute for providing an email reminder. These machine-readable instructions may be incorporated into a larger set of machine-readable instructions which provide a complete email software program, or they may comprise a stand-alone program for use in conjunction with separate machine-readable computer instructions for an email software program.

Memory 202 also stores information used in conjunction with providing an email reminder. For example, an identification of outgoing emails and their respective, recipients, subjects, date and time sent, predetermined time period, etc may be stored within memory 202. It should be understood that memory 202 may comprise more than one type of memory, each suitable for the particular type of data being stored.

User interface 204 comprises, generally, a keyboard or keypad, and a visual display device, such as a computer monitor, LED display, or the like. A user of apparatus 104 may enter commands to compose and send an outgoing email, and to request an email reminder for the outgoing email. Of course, apparatus 104 can generally be used for other applications, such as allowing voice or data communications or offering a host of computer-related functionality, such as word processing, calendaring, receiving streaming audio or visual media, and so on.

Network interface 206 comprises circuitry for allowing digital communications, including email, between apparatus 102 and apparatus 104. Network interface 206 might comprise a dial-up modem, a wireless modem, a cable modem, a Digital Subscriber Line (DSL) modem, or other device for sending and receiving digital communications. Network interface 206 interfaces to processor 200 and sends email from processor 200 to data network 106 and vice-versa.

FIG. 3 comprises an illustration representing a signal-bearing medium 300 tangibly embodying a program of machine-readable instructions executable by a digital processing apparatus to perform a method for providing an email reminder. The program of machine-readable instructions comprise executable instructions that allow processor 200 to provide an email reminder, as described below. The machine-readable instructions may be “bundled” with other machine-readable instructions for performing other tasks. For example, the machine-readable instructions for providing an email reminder may be embedded in machine-readable instructions relating to an operating system, such as Microsoft Windows. Although signal-bearing medium 300 is shown in FIG. 3 as a CD-ROM (compact disc-read only memory), signal-bearing medium could alternatively comprise a “zip” disk, a “floppy” disk, an optical disk, any form of re-writeable CD-ROM, a programmable read-only memory (PROM), a read-only memory (ROM), an electrically-erasable read-only memory (EEPROM), an ultra-violet read-only memory (UVPROM), a flash memory, a hard drive, a tape drive, or other type of electronic or optical memory.

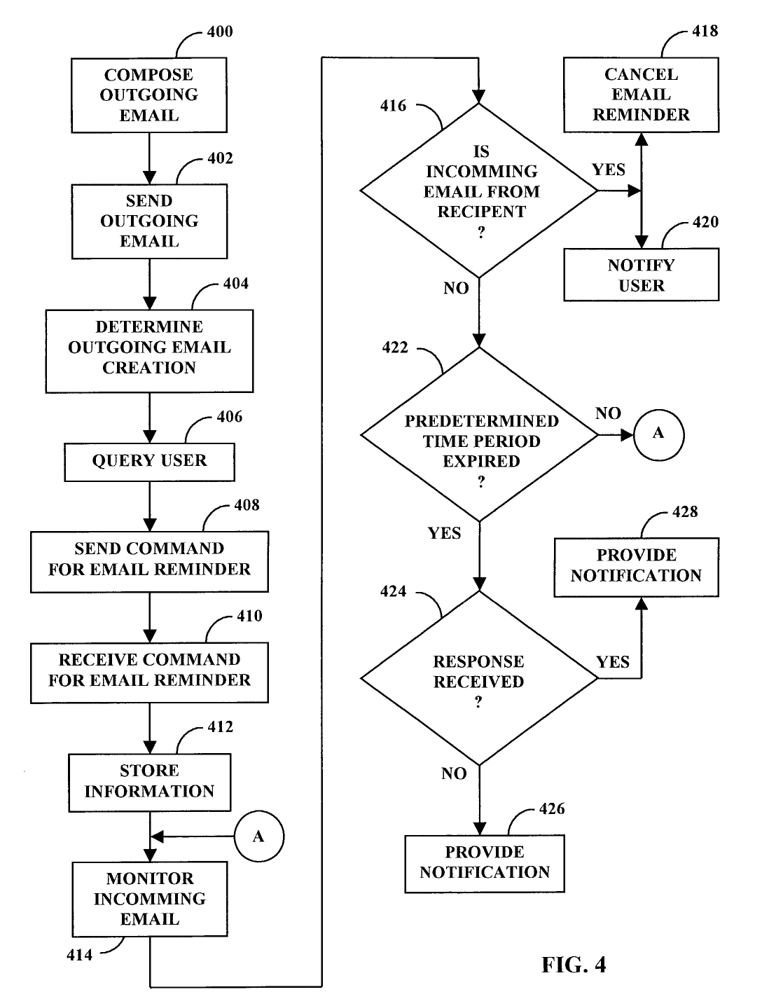

FIG. 4 is a flow diagram illustrating a method for providing an email reminder. It should be understood that the method illustrated is for purposes of illustration, and that other embodiments may contain more, or fewer, steps, or that the steps shown in FIG. 4 might be performed in a different order.

In step 400, a user of apparatus 104 composes an outgoing email message using user interface 204 for transmission to one or more recipients. An identification of one ore more recipients is entered in either the “To” field, the “CC” field (carbon copy), the “BCC” field (blind carbon copy), or other field designated for identification of an email recipient. The identification generally comprises an email address. In another embodiment, the name of each recipient is used instead of an email address, as many email programs today automatically insert a recipient's name with a corresponding email address. In step 402, the user enters one or more commands using interface 204 to send the outgoing email message to the one or more recipients.

In step 404, processor 200 determines that an outgoing email has been created by receipt of the command(s) in step 402. In step 406, in response to the creation of an outgoing email, processor 200 provides a query to the user asking whether the user would like to be provided with an email reminder. The query could comprise a text-based message or an audible message. The query might request that the user select a predetermined time period in which to be reminded, or the query might simply ask whether the user desires an email reminder for the current outgoing message, in which case the predetermined time period comprises a default time period, such as three days.

If the user decides that he or she would like to be provided with an email reminder, a command to do so is entered using user interface 204, as shown in step 408. The command might be made by simply entering an affirmative response to the request if a default time period is used, or the user can enter a predetermined time period in which to be reminded, if a default time period is not used, or if the user would like to override a default time period.

In the case of multiple recipients, the command may identify only a partial list of recipients that the user wishes to be included when determining whether an email response to the outgoing email has been received. In another embodiment, all recipients of an outgoing email are used to determine if a response to the outgoing email has been received. In yet another embodiment, all recipients are used to determine if a response to the outgoing email has been received, allowing for the user to override the default if the user wishes to select only certain recipients. In still another embodiment, the user may assign a predetermined time period for an email reminder for each recipient selected. This, in essence, provides for the creation of an email reminder for each recipient selected. In any case, the command to provide an email reminder is sent to processor 200 where it is received, as shown in step 410.

It should be understood that a request to provide an email reminder can be accomplished in other ways than the method described in steps 404 through 410. For example, in another embodiment, a user may compose and then send an outgoing email message. Subsequently, the user may decide that he or she would like an email reminder for the outgoing email message. The user may, at this time, enter one or more commands using user interface 204 to request an email reminder for the previously-sent outgoing email message. The command to provide an email reminder, in this case, comprises an identification of the previously-sent outgoing email. It may also comprise information previously discussed, such as a predetermined time period in which to provide an email reminder, a selection of recipients to be included in the email reminder, and so on.

In another embodiment, the use of a predetermined key used in conjunction with an instruction to send an outgoing email may be used to initiate a request to provide an email reminder. For example, after a user has created an outgoing email message, the message is sent without an email reminder by depressing an “Enter” key located on user interface 204. If, instead, an email reminder associated with the outgoing message is desired, the user depresses the predetermined key, for example, the “Control” key, simultaneously with the “Enter” key, to request an email reminder. In response to this, processor 200 may send a query asking whether the user would like to be provided with an email reminder. The user would then enter a command for an email reminder, comprising any of the information discussed above, such as a predetermined time period in which to provide an email reminder, a selection of recipients to be included in the email reminder, and so on, and this command would be sent to processor 200.

After the command to provide an email reminder has been received by processor 200 in step 410, processor 200 stores information pertaining to the email reminder in memory 202, as shown in step 412. For example, processor 200 may store an email address of one or more recipients of the outgoing email chosen for an email reminder. Other information may be stored as well, such as an identification of the outgoing email, the outgoing email message content, the subject matter of the outgoing email, the date and time that the outgoing email was sent, the date and time that the command to provide an email reminder was entered, selected recipients to monitor for incoming email, the predetermined time period selected for each recipient chosen, and so on. In another embodiment, the computer program providing email service is relied upon to store much or all of the information just mentioned in memory 202. In another embodiment, some information is stored by an email program and other information is stored by the executable instructions for providing an email reminder.

Next, in step 414, processor monitors incoming emails from network interface 206. As emails are received, processor 200 determines whether any of them are from a recipient identified in the outgoing email and stored in memory 202, as shown in step 416. This may be accomplished in a number of ways. For example, processor 200 may compare the information in the “From” field in an incoming email to a list of recipients stored in memory 202. In another embodiment, the “Subject” field is compared to a list of subjects stored in memory 202. In another embodiment, both the “From” field and the “Subject” field is compared to information stored in memory 202. If one, or both, matches comparable information stored in memory 202, a match is determined. In yet another embodiment, an IP address of each email received is compared to a list of IP addresses each corresponding to a recipient of an outgoing email message. In yet another embodiment, the user, or processor 200, appends an identification code to the outgoing email and stores it in memory 202 prior to sending the outgoing email. When a response email is received, processor 200 determines if any of the header fields of the incoming email contains an identification code, and compares it to what is stored in memory 202. If a match if found, the incoming email is determined to be from the recipient of the outgoing email. It should be understood that any of these techniques may be used individually, or in any combination with each other.

If a match is not found, further incoming emails are monitored, and processing reverts back to step 414. In addition, processing continues to step 422, described below. If a match is found, processor 202 determines that a response from a recipient of the outgoing email has responded, and, in one embodiment, the email reminder is cancelled, as shown in step 418. That is, a notification is not provided to the user indicating that the recipient has responded to the outgoing email, and no action is taken by processor 200 in response to the predetermined time period expiring (or a countdown timer, described below, is canceled). In another embodiment, shown in step 420, a notification is provided to the user indicating that a response to the outgoing email has been received, and no further action is taken by processor 200 when the predetermined time period expires (or the countdown timer is canceled). In this embodiment, other information may be provided as well, such as a list of recipients who have yet to respond to the outgoing email, an indication of recipients who have already responded to the outgoing email, the dates/times of the responses, an opportunity for the user to modify or cancel an email reminder for remaining recipients, etc. In yet another embodiment, an indication is stored in memory 202 indicating that a response from a recipient of the outgoing email message has been received, possibly including the date/time that the response was received, and/or other pertinent information.

In step 422, processor 200 determines if the predetermined time period to respond to the outgoing email has been expired, generally by comparing the current date and time to the date and time that the outgoing email was sent (or command to provide an email notification was entered) plus the predetermined time period. In another embodiment, a countdown timer is used from the either the time that the outgoing email was sent, or the time that a command to provide an email response was entered by the user. When the countdown timer expires, a notification is provided to processor 200. The countdown timer may be implemented in hardware or in software, and is well known in the art.

In the case of an outgoing email having multiple recipients, processor 200 determines if the predetermined time period for each selected recipient has expired or not, using the techniques just described. In another embodiment, a single predetermined time period is used, and processor 200 determines if this time period has expired, much the same as described in the preceding paragraph.

If the predetermined time period has expired, processor 200 determines if a response to the outgoing email has been received, as shown in step 424. Processor may consult memory 202 to determine if an indication of a response to the outgoing email has been received. In another embodiment, processor 200 assumes that a response has not been received if the predetermined time period expires.

If no response to the outgoing email has been received, processor 200 provides a notification of such to the user via user interface 204, as shown in step 426. The notification may be an audio and/or a visual indication, such as a predetermined sound, a pop-up window, or an email message placed in the user's email “inbox” or otherwise sent to the user via email, in which case the user is notified generally when the user checks for new email. The notification may provide information pertaining to the reminder, such as one or any combination of the following: an indication of which email was not responded to, a list of recipients who have not responded by the predetermined time period and/or their corresponding email addresses, a list of recipients who have responded and/or their corresponding email addresses, the text of the outgoing email, the subject matter of the outgoing email, the time and date that the outgoing email was sent, the time and date that the command to provide an email response was entered, and the predetermined time period used to calculate the notification, among others.

If the predetermined time period expires and processor 200 determines that a response to the outgoing email was received (step 424), a notification is not provided to the user indicating that a recipient has responded to the outgoing email. In another embodiment, as shown in step 428, a notification is provided to the user indicating that a response to the outgoing email has been received, the notification possibly containing any one or a combination of the following: an indication of which email was responded to, a list of recipients who have not responded by the predetermined time period and/or their corresponding email addresses, a list of recipients who have responded and/or their corresponding email addresses, the text of the outgoing email, the subject matter of the outgoing email, the time and date that the outgoing email was sent, the time and date that the command to provide an email response was entered, and the predetermined time period used to calculate the notification.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

I claim:

1. A method for providing an email reminder, comprising:
receiving a command to provide an email reminder to an outgoing email;
determining whether or not a response email from a recipient of said outgoing email has been received subsequent to said command; and
providing a notification if said response email from said recipient has not been received within a predetermined time period.

2. The method of claim 2 wherein determining whether or not an email from said recipient has been received comprises:
monitoring incoming email messages;
determining if any one of said email messages comprises information identifying said recipient; and
declaring that a response email from said recipient has been received if said information matches said recipient.

3. The method of claim 1 wherein receiving a command to provide an email reminder comprises:
determining that said outgoing email has been created;
providing a query to a user asking whether said user would like to be provided with said email reminded; and
receiving said command in response to said query.

4. The method of claim 1 wherein said predetermined time period is selected by a sender of said outgoing email.

5. The method of claim 1 wherein said predetermined time period is selected by a user who composed said outgoing email.

6. The method of claim 1 further comprising:
sending a second notification if a response email from said recipient is received within said predetermined time period.

7. The method of claim 1 wherein said predetermined time period is associated with a response to said outgoing email.

8. The method of claim 1 wherein said predetermined time period is associated with a response by said recipient.

9. The method of claim 1, further comprising the steps of:
determining that said outgoing email has been sent; and
querying a sender of said outgoing email if said sender would like to receive said email reminder.

10. A signal-bearing medium tangibly embodying a program of machine-readable instructions executable by a digital processing apparatus to perform a method for providing an email reminder, said method comprising operations of:
receiving a command to provide an email reminder to an outgoing email;
determining whether or not a response email from a recipient of said outgoing email has been received subsequent to said command; and
providing a notification if said response email from said recipient has not been received within a predetermined time period.

11. The signal-bearing medium of claim 10 wherein determining whether or not an email from said recipient has been received comprises:
monitoring incoming email messages;
determining if any one of said email messages comprises information identifying said recipient; and
declaring that a response email from said recipient has been received if said information matches said recipient.

12. The signal-bearing medium of claim 10 wherein receiving a command to provide an email reminder comprises:
determining that said outgoing email has been created;
providing a query to a user asking whether said user would like to be provided with said email reminded; and
receiving said command in response to said query.

13. The signal-bearing medium of claim 10 wherein said predetermined time period is selected by a sender of said outgoing email.

14. The signal-bearing medium of claim 10 wherein said predetermined time period is selected by a user who composed said outgoing email.

15. The signal-bearing medium of claim 10 further comprising operations of:
sending a second notification if a response email from said recipient is received within said predetermined time period.

16. The signal-bearing medium of claim 10 wherein said predetermined time period is associated with a response to said outgoing email.

17. The signal-bearing medium of claim 10 wherein said predetermined time period is associated with a response by said recipient.

18. The signal-bearing medium of claim 10, further comprising:
determining that said outgoing email has been sent; and
querying a sender of said outgoing email if said sender would like to receive said email reminder.

19. An apparatus for providing an email reminder, comprising:
a user interface for allowing a user to request a notification if a response to an outgoing email has not been received within a predetermined time period, and for providing said notification to said user;
a memory for storing a recipient of said outgoing email;
a network interface for sending said outgoing email and for receiving said response; and.
a processor for determining whether or not said response has been received from said recipient within a predetermined time period, and for providing said notification if said response is not received within said predetermined time period.
